(19) United States
(12) Patent Application Publication
(10) Pub. No.: US 2020/0325864 A1
(43) Pub. Date: Oct. 15, 2020

(54) TRV SHUTOFF VALVE

(71) Applicant: CUMMINS FILTRATION IP, INC., Columbus, IN (US)

(72) Inventors: Wassem Abdalla, Cookeville, TN (US); Mehvish Jamil, Lucknow (IN); Hariprasad Mohan Bhalerao, Pune (IN)

(73) Assignee: CUMMINS FILTRATION IP, INC., Columbus, IN (US)

(21) Appl. No.: 16/955,174

(22) PCT Filed: Dec. 20, 2018
(86) PCT No.: PCT/US2018/066751

§ 371 Date: Jun. 18, 2020

(30) Foreign Application Priority Data
Dec. 21, 2017 (IN) 201741045990

(51) Int. Cl. F02M 37/30; F02M 37/48; B01D 35/157

(52) U.S. Cl. CPC F02M 37/30; B01D 2201/167; B01D 35/1573; F02M 37/48

(57) ABSTRACT

According to a set of embodiments, the filtration system includes a housing with a fuel inlet and a fuel outlet. A pump is in fluid communication with the fuel outlet. A fuel tank is in fluid communication with the fuel inlet. A thermal recirculation valve includes a thermal recirculation valve inlet and a thermal recirculation valve outlet. The thermal recirculation valve inlet receives heated fuel and the thermal recirculation valve outlet is in fluid communication with the fuel tank. A fluid passage is between the thermal recirculation valve inlet and the thermal recirculation valve outlet. A passage blocking mechanism having a first position and a second position. The passage blocking mechanism is structured to prevent fluid flow through the fluid passage when in the first position. The passage blocking mechanism is structured to allow fluid flow through the fluid passage when in the second position.

### CROSS-REFERENCE TO RELATED APPLICATIONS

The present application claims priority to Indian Provisional Patent Application No. 201741045990, filed Dec. 21, 2017 and the contents of which are incorporated herein by reference.

### TECHNICAL FIELD

The present application relates to filter elements for filtering fluids in internal combustion engine systems or the like.

### BACKGROUND

A thermal recirculation valve (“TRV”) is a valve structured for high resolution temperature control of the fuel. The TRV is designed to control the return flow of heated fuel back into the module to increase the temperature of the fuel before the fuel flows from the module, thereby providing precise temperature control of the supply fuel that is delivered downstream to the high-pressure pump and/or other downstream components. The TRV offers improved performance due to its unique positioning and internal sealing that allows for temperature control. For example, the TRV can facilitate the delivery of hot return fuel to filter in cold conditions and facilitate drainage back to the tank on normal working mode.

A priming operation is used to remove all air from the system and this is achieved by various pump mechanisms, like manual or electric. During priming, dirty fuel is pulled from the tank by suction created by the priming pump, which then travels through media and goes to the outlet side and removes all air during this phase. Because the TRV passage is connected to the tank, if the TRV passage is not blocked during priming, then there is a risk that that air will be sucked from the tank by suction created by pump. This extra air increases efforts of priming, drastically increasing the number and force of pumping strokes to remove all air.

### SUMMARY

Various example embodiments relate to a filtration system and method for the installation and use of such a filtration system. According to a set of embodiments, the filtration system includes a housing with a fuel inlet and a fuel outlet. A pump is in fluid communication with the fuel outlet. A fuel tank is in fluid communication with the fuel inlet. A thermal recirculation valve includes a thermal recirculation valve inlet and a thermal recirculation valve outlet. The thermal recirculation valve inlet receives heated fuel and the thermal recirculation valve outlet is in fluid communication with the fuel tank. A fluid passage is between the thermal recirculation valve inlet and the thermal recirculation valve outlet. A passage blocking mechanism having a first position and a second position. The passage blocking mechanism is structured to prevent fluid flow through the fluid passage when in the first position. The passage blocking mechanism is structured to allow fluid flow through the fluid passage when in the second position.

Various other example embodiments relate to a thermal recirculation valve. The thermal recirculation valve includes an inlet side and an outlet side. The inlet side receives heated fuel, and the outlet side is in fluid communication with a fuel tank. A fluid passage is between the inlet side and the outlet side. A passage blocking mechanism has a first position and a second position. The passage blocking mechanism is structured to prevent fluid flow through the fluid passage when in the first position. The passage blocking mechanism is structured to allow fluid flow through the fluid passage when in the second position.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 shows a filtration system with a TRV, according to an example embodiment.

FIG. 2A shows a perspective view of a filtration system with a TRV that includes a pin member and groove shutoff valve in a first position, according to an example embodiment.

FIG. 2B shows a perspective view of the filtration of FIG. 2A in a second position.

FIG. 2C shows a cross-sectional view of the filtration system of FIG. 2B in the second position

FIG. 2D shows a cross-sectional view of the filtration system of FIG. 2C.

FIG. 3A shows a perspective view of a filtration system with a TRV that includes a rack and pinion shutoff valve in a first position, according to an example embodiment.

FIG. 3B shows a cross-sectional view of the filtration of FIG. 3A.

FIG. 3C shows a perspective view of the filtration system of FIG. 3A in a second position

FIG. 3D shows a cross-sectional view of the filtration system of FIG. 3C.

FIG. 4A shows a cross-sectional view of a filtration system with a TRV that includes an axial seal in a first position, according to an example embodiment.

FIG. 4B shows a cross-sectional view of the filtration system of FIG. 4A in a second position.

### DETAILED DESCRIPTION

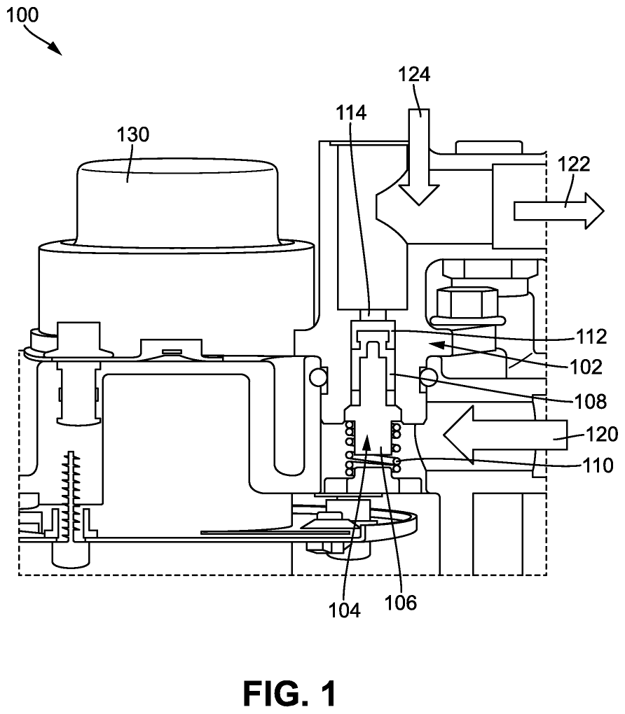

Referring to the figures generally, a filtration system that includes a TRV with a shutoff valve is described. The shutoff valve is configured to disable TRV flow passage during priming and block air coming from the tank by suction created by a pump. During priming operations in filtration system 100 using a TRV 104 with no shutoff valve, as shown in FIG. 1, suction created by the priming pump 130 may suck or draw air from the tank back to the filter since the TRV 104 is also connected to the tank. As shown in FIG. 1, the TRV 104 is disposed with a TRV housing 102 and includes a biasing member 110, a plunger 108, and a base 106. The plunger 108 extends from the base 106 away from the biasing member 110 towards a TRV passage 114. In some embodiments, the base 106 and the plunger 108 are a single piece or are otherwise formed as an integral piece. A seal member 112 is disposed on an end of the plunger 108 and is configured to seal the passage 144 during a priming operation. Under normal operation, fuel enters the TRV housing 102 along a first flow path 120 and flows back to the tank along a second flow path 122. A third flow path 124 may allow for return flow into the TRV housing 102 and the filter. By isolating the TRV from the filter during priming, it is less likely that air from the tank is sucked to the filter either through the third flow path 124 or in reverse along the second flow path 122.

According to various embodiments, a TRV with a shutoff valve (herein referred to as a “TRV shutoff valve”) is therefore provided that may include a seal member, plunger, and other configurations to allow or block airflow through a passage along the TRV shutoff valve. The seal member (e.g., rubber gasket) and plunger may engage with the passage to block airflow through the passage or disengage with the passage to allow airflow through the passage. In some embodiments, the shutoff valve is manually activated during priming and then set to an original position that allows for normal functioning of the TRV in the TRV housing. In other embodiments, the TRV shutoff valve is automatically activated during priming and manually or automatically returns to an original portion that allows for normal functioning of the TRV in the TRV housing.

Beneficially, various components of the TRV shutoff valve may be integrally formed to limit the number of components and provide ease of manufacture. Various engagement interfaces for the TRV shutoff valve may be used, including a pin-groove, rack and pinion, screw-in type plunger, push-in type plunger, O-ring and port edge, and similar engagement components. The TRV shutoff valve may be formed with rounded or non-sharp edges to limit the risk of cutting the seal. The TRV shutoff valve may include a fail-safe mechanism that will shut down the TRV shutoff valve in a way that does not affect the filter or engine if the TRV shutoff valve is improperly operated.

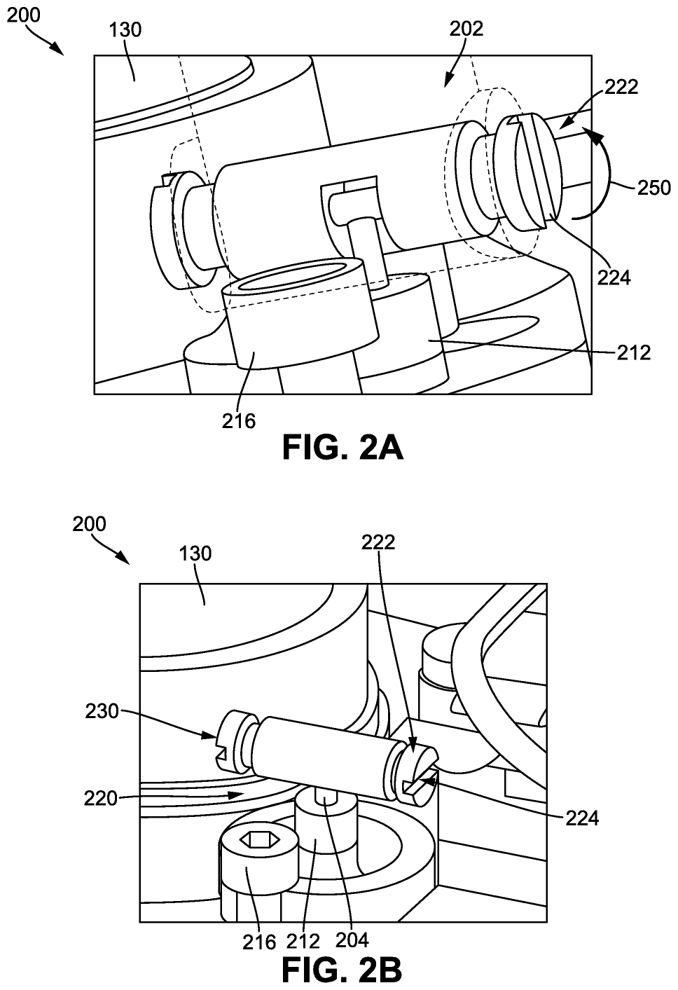

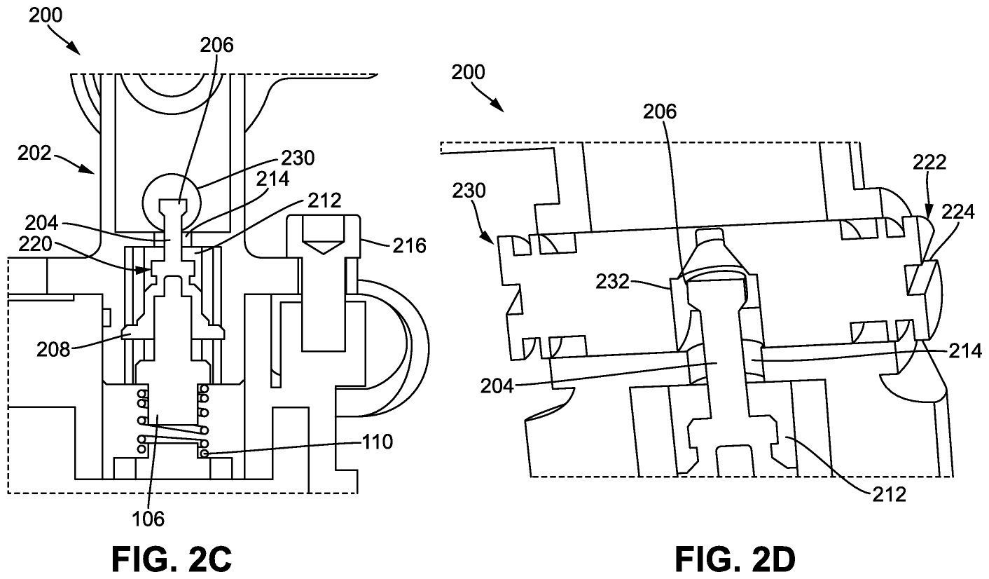

According to a first embodiment, a TRV shutoff valve 220 with a pin member 204 and groove surface 206 configuration is described. Referring to FIGS. 2A-2D, the filtration system 200 includes a TRV shutoff valve 220 configured to engage handle 230 to open and close a TRV passage 214. The handle 230 is used to operate the TRV shutoff valve 220 during priming of the filtration system 200. The TRV shutoff valve 220 includes the base 106, biasing member 110, seal member 112, and plunger 208. The plunger 208 includes a pin member 204 and groove surface 206 that is disposed on an end of the pin member 204. The pin member 204 may extend from an inlet side of the TRV passage 214, through the TRV passage 214 to an outlet side of the TRV passage 214. The groove surface 206 is configured to engage a handle slot 232 disposed within the handle 230. In other embodiments, the groove surface 206 and/or a portion of the pin member 204 are configured to engage the handle slot 232 provided in a handle 230 used to operate the filtration system 200 during priming. The seal member 112 (e.g., rubber seal) is mounted on the pin member 204, or other portion of the plunger 208 that has the requisite profile on the inlet side of the TRV passage 214.

In FIG. 2A, the filtration system 200 is in an operating position (e.g., running) with the TRV shutoff valve 220 disposed within the handle 230 allowing flow through one or more flow passages 216. The TRV shutoff valve 220 and the handle 230 are disposed within the TRV housing 202. When there is a need to prime the filtration system, a lock member 222 on the handle 230 is rotated 250 approximately 90-degrees or more, until the handle slot 232 provided in a handle 230 (or other valve head) engages the TRV shutoff valve 220, as shown in FIGS. 2B-2D. In some embodiments, the lock member 222 may comprise other movable features that move to transition the filtration system 200 between an operational and a priming state. In some embodiments, the lock member 222 is activated automatically, while in other embodiments, the lock member 222 is manually activated by a user rotating the handle 230. The lock member 222 may be rotated by inserting a rotation member into the lock slot 224 and rotating the rotation member within the lock slot 224. When the lock member 222 is rotated and locks the TRV shutoff valve 220 in place, it prevents the TRV shutoff valve 220 from opening up under suction. In some embodiments, locking the TRV shutoff valve 220 includes the seal member 212 being disposed around an end, and covering a TRV passage 214 disposed within the TRV housing 202. When the operator (e.g., user) is done with priming, the operator will turn the lock member 222 on the handle 230 counter-clockwise to release the TRV shutoff valve 220.

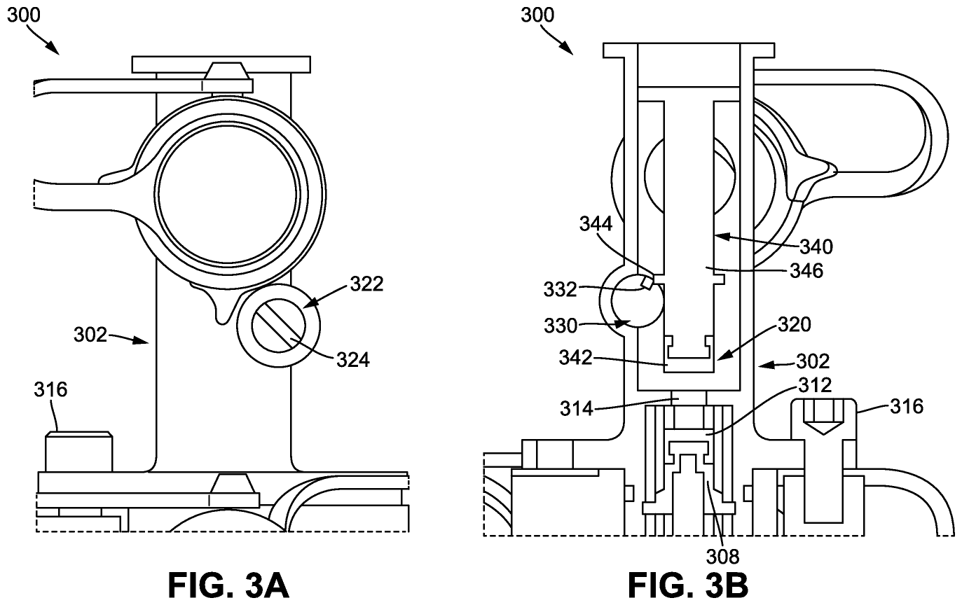

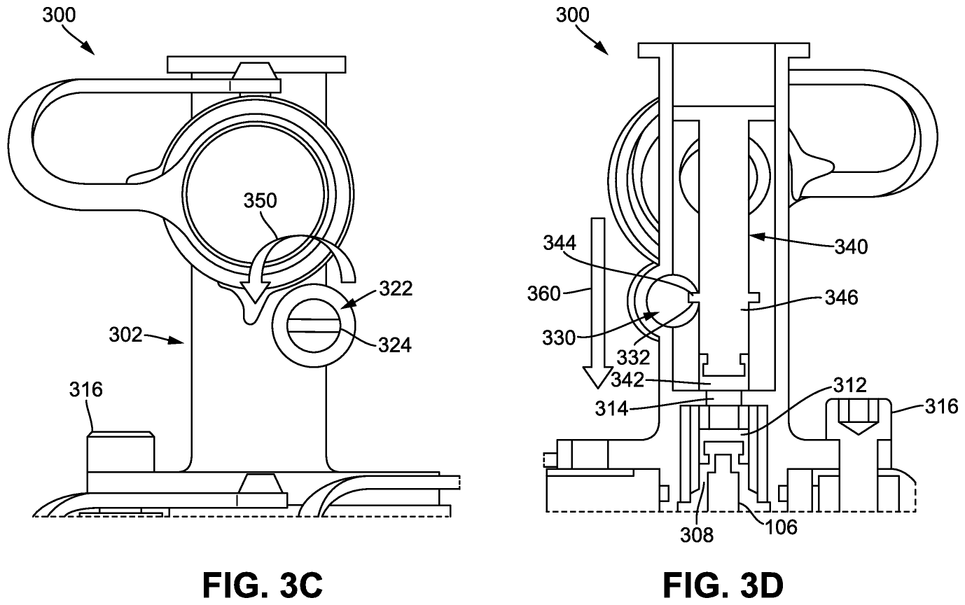

According to a second embodiment, a TRV shutoff valve 320 with a rack member 340 and pinion 332 configured to open and close a TRV passage 314 is described. Referring to FIGS. 3A-3D, the filtration system 300 includes a TRV shutoff valve 320 that includes a handle 330 with an internal pinion 332 (e.g., a slot shaped gear profile) that is configured to engage a rib portion 344 (e.g., gear tooth) on a rack member 340. The TRV shutoff valve 320, the rack member 340, and the handle 330 are disposed within a TRV housing 302. The handle 330 may include a lock member 322 with a lock slot 324 that can enable a user to manually rotate the handle 330. In some embodiments, the handle 330 includes multiple slots or pinions 332. The rack seal member 342 is positioned such that air flows through the TRV passage 314 when the TRV shutoff valve 320 is in an open position and air flow through the TRV passage 314 is blocked when the TRV shutoff valve 320 is a closed position. As shown in FIG. 3B, the rack member 340 is aligned with the base 106, plunger 308, and seal member 312 such that the rack member 340 is disposed opposite of the base 106, plunger 308, and seal member 312 about the TRV passage 314. The seal member 312 is disposed on an end of the plunger 308 adjacent the TRV passage 314. The rack member 340 includes a pin portion 346, a rack seal member 342 disposed on an end of the pin portion 346 adjacent the TRV passage 314, and a rib portion 344. The rib portion 344 is configured to engage or receive the pinion 332 disposed within the handle 230 when a lock member 322 on the handle 230 is rotated. In some embodiments, the pinion 332 may engage another feature on a rack member 340.

As shown in FIG. 3A, the filtration system 300 is in an operating position (e.g., running) with the TRV shutoff valve 320 disposed with the handle 230 within the TRV housing 302 allowing flow through one or more flow passages 316. As shown in FIG. 3B, in the operating position, the rib portion 344 is not disposed within the pinion 332, and the rack seal member 342 is disposed away from the TRV passage 314 and allows airflow therethrough. Specifically, the rack member 340 is disposed on one side of the TRV passage 314 and the base 106, plunger 308, and seal member 312 are disposed on another side of the TRV passage 314. As shown in FIG. 3C, when there is a need to prime the filtration system, the lock member 322 is rotated 350 to cause the pinion 332 to rotate and engage the rib portion 344. When the pinion 332 engages and rotates the rib portion 344, the TRV shutoff valve 320 is configured to translate the rotary motion 350 of the handle 330 into vertical motion 360 of the rack member 340, as shown in FIG. 3D. The vertical motion 360 of the rack member 340 activates the rack seal member 342 to close the TRV passage 314 (e.g., block airflow therethrough). When the operator (e.g., user) is done with priming, the operator will turn the lock member 322 on the handle 330 counter-clockwise to release the TRV shutoff valve 320 by causing the counter-clockwise rotary motion of the handle 330 into upward vertical motion of the rack member 340 and remove the rack seal member 342 from the TRV passage 314. In some embodiments, the plunger 308 and seal member 312 on the base 106 are configured to move vertically to block the other end of the TRV passage 314. In some embodiments, the lock member 322 may comprise other movable features that move to transition the filtration system 300 between an operational and a priming state. In some embodiments, the lock member 322 is activated automatically, while in other embodiments, the lock member 322 is manually activated by a user rotating the handle 330 with, for example, a screw driver or similar tool.

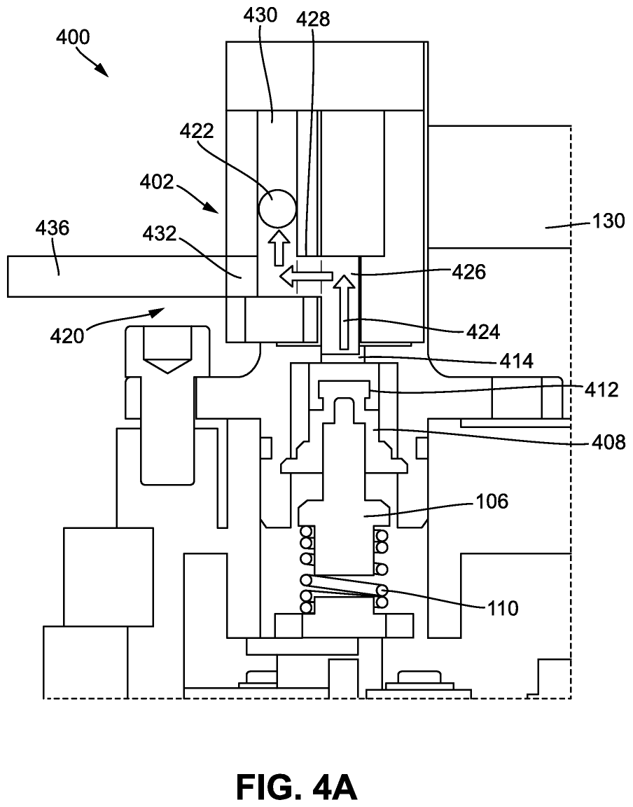

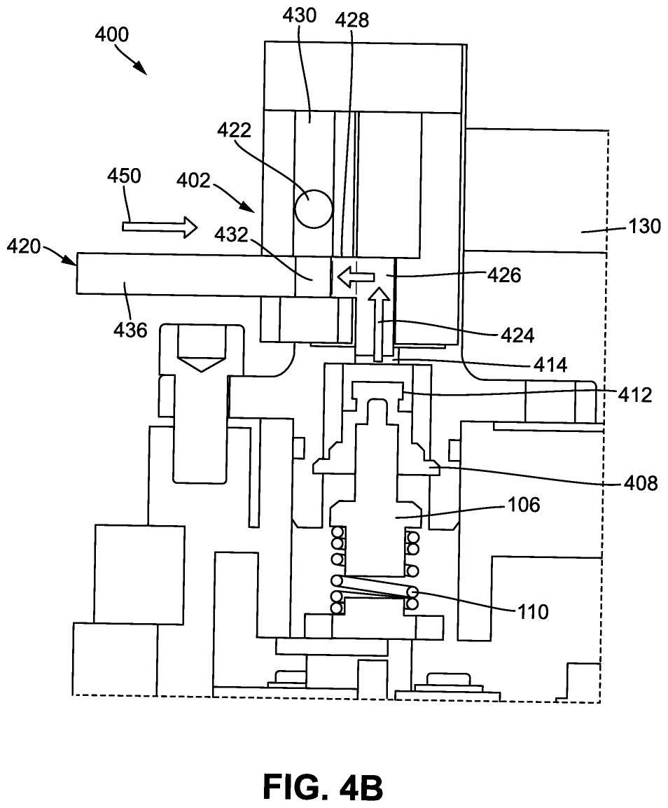

According to a third embodiment, a TRV shutoff valve 420 with an axial valve seal member 432 to block a cross flow passage 428 (e.g., TRV passage) is described. Referring to FIGS. 4A and 4B, the filtration system 400 includes a TRV shutoff valve 420 that includes a plunger 436 and a valve seal member 432 mounted on an end of the plunger 436. The TRV shutoff valve 420 is disposed within the TRV housing 402. In some embodiments, the TRV shutoff valve 420 is connected to the TRV housing 402 by complementary threaded members, a push member, or other engagement members that allow for axial movement of the plunger 436 of the TRV shutoff valve 420. The TRV housing 402 includes a first passage 426 and a second passage 430 connected, or coupled, by a cross flow passage 428 that allows a flow of fluid 424 therethrough. In some embodiments, the first passage 426 is for return flow and the second passage 430 may be for flow to the filter. The plunger 436 and the valve seal member 432 of the TRV shutoff valve 420 are aligned with the cross flow passage 428 such that the plunger 436 can be activated or deactivated to block or open up the cross flow passage 428. The seal member 432 may have a diameter (or length and width in situations where there is no circular configuration) that is substantially similar to, or greater than, the diameter of the cross flow passage 428. The filtration system 400 includes a base 106, biasing member 110, plunger 408, and seal member 412 disposed adjacent to a TRV passage 414 outside of the first passage 426 and the second passage 430.

As shown in FIG. 4A, during normal operation of the filtration system 400, the plunger 436 and the valve seal member 432 are disposed away from the cross flow passage 428 such that the TRV shutoff valve 420 does not block the cross flow passage 428. With the valve seal member 432 not blocking the cross flow passage 428, the flow of fluid 424 in the first passage 426 is open (e.g., in fluid communication with) to the flow to the second passage 430 and into the flow passage 422 back to the tank. During a priming operation, as shown in FIG. 4B, the TRV shutoff valve 420 is activated and the plunger 436 moves toward the cross flow passage 428. The movement 450 of the plunger 436 axially inward causes the valve seal member 432 to move axially toward the cross flow passage 428 to block flow through the cross flow passage 428, thereby preventing any back flow. In some embodiments, an operator activates the TRV shutoff valve 420 by rotating or pushing the plunger 436, causing the plunger 436 to axially move the valve seal member 432 toward the cross flow passage 428 to block flow through the cross flow passage 428. As will be appreciated, when the valve seal member 432 blocks the cross flow passage 428, the return flow in the first passage 426 is blocked from the flow to the filter in the second passage 430.

It should be noted that any use of the term “example” herein to describe various embodiments is intended to indicate that such embodiments are possible examples, representations, and/or illustrations of possible embodiments (and such term is not intended to connote that such embodiments are necessarily extraordinary or superlative examples).

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various example embodiments are illustrative only. Although only a few embodiments have been described in detail in this disclosure, those skilled in the art who review this disclosure will readily appreciate that many modifications are possible without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Additionally, features from particular embodiments may be combined with features from other embodiments as would be understood by one of ordinary skill in the art. Other substitutions, modifications, changes and omissions may also be made in the design, operating conditions and arrangement of the various example embodiments without departing from the scope of the present invention.

1. A filtration system, comprising:
a housing with a fuel inlet and a fuel outlet;
a pump in fluid communication with the fuel outlet;
a fuel tank in fluid communication with the fuel inlet; and
a thermal recirculation valve, the thermal recirculation valve comprising:
a thermal recirculation valve inlet and a thermal recirculation valve outlet, wherein the thermal recirculation valve inlet receives heated fuel and the thermal recirculation valve outlet is in fluid communication with the fuel tank;
a fluid passage between the thermal recirculation valve inlet and the thermal recirculation valve outlet; and
a passage blocking mechanism having a first position and a second position, the passage blocking mechanism structured to prevent fluid flow through the fluid passage when in the first position and structured to allow fluid flow through the fluid passage when in the second position, the passage blocking mechanism comprising a seal member configured to prevent fluid flow through the fluid passage when the passage blocking mechanism is in the first position.

2. The filtration system of claim 1, wherein the passage blocking mechanism further comprises:
a base disposed on an inlet side of the fluid passage;
a plunger connected to the base comprising a first plunger portion and a second plunger portion, the second plunger portion extending through the fluid passage to an outlet side of the fluid passage; and
the seal member disposed on the first plunger portion.

3. The filtration system of claim 2, wherein the passage blocking mechanism further comprises a handle comprising a handle slot disposed within, the handle slot configured to receive the second plunger portion, the handle comprising a first handle position and a second handle position, wherein in first handle position the handle slot is configured to engage the second plunger portion and cause the passage blocking mechanism to transition to the first position and prevent fluid flow through the fluid passage, and wherein in the second handle position the handle slot is configured to release the second plunger portion and cause the passage blocking mechanism to transition to the second position and allow fluid flow through the fluid passage.

4. The filtration system of claim 3, wherein the seal member comprises a first seal position when the passage blocking mechanism is in the first position and a second seal position when the passage blocking mechanism is in the second position, wherein in the first seal position the seal member covers the fluid passage to prevent fluid flow through the fluid passage and in the second seal position the seal member is disposed away from the fluid passage toward the thermal recirculation valve inlet and allows fluid flow through the fluid passage.

5. The filtration system of claim 3, wherein the handle further comprises an actuating member, the actuating member rotatable to transition the handle from the first handle position to the second handle position.

6. The filtration system of claim 1, wherein the passage blocking mechanism comprises
a plunger comprising a first plunger end and a second plunger end, the plunger disposed on an outlet side of the fluid passage;
a rib portion disposed between the first plunger end and the second plunger end; and
the seal member disposed on the second plunger end.

7. The filtration system of claim 6, wherein the passage blocking mechanism further comprises a handle comprising a pinion disposed within, the pinion configured to engage the rib portion, the handle comprising a first handle position and a second handle position, wherein in first handle position pinion is configured to engage the rib portion and cause the passage blocking mechanism to transition to the first position and prevent fluid flow through the fluid passage, and wherein in the second handle position the pinion is configured to release the rib portion and cause the passage blocking mechanism to transition to the second position and allow fluid flow through the fluid passage.

8. The filtration system of claim 7, wherein the handle further comprises an actuating member, the actuating member rotatable to transition the handle from the first handle position to the second handle position, wherein rotation of the actuating member causes vertical motion of the plunger.

9. The filtration system of claim 7, wherein the seal member comprises a first seal position when the passage blocking mechanism is in the first position and a second seal position when the passage blocking mechanism is in the second position, wherein in the first seal position the seal member covers the fluid passage to prevent fluid flow through the fluid passage and in the second seal position the seal member is disposed away from the fluid passage toward the thermal recirculation valve inlet and allows fluid flow through the fluid passage.

10. The filtration system of claim 1, wherein the passage blocking mechanism further comprises:
a plunger connected to the thermal recirculation valve outlet and the plunger aligned with the fluid passage, the plunger comprising a first plunger end and a second plunger end, the plunger movable to transition the passage blocking mechanism between the first position the second position; and
the seal member disposed on the second plunger end, the seal member being aligned with the fluid passage, the seal member having a diameter at least equal to a diameter of the fluid passage.

11. A thermal recirculation valve, the thermal recirculation valve comprising:
an inlet side and an outlet side, wherein the inlet side receives heated fuel and the outlet side is in fluid communication with a fuel tank;
a fluid passage between the inlet side and the outlet side; and
a passage blocking mechanism having a first position and a second position, the passage blocking mechanism structured to prevent fluid flow through the fluid passage when in the first position and structured to allow fluid flow through the fluid passage when in the second position, the passage blocking mechanism comprising a seal member configured to prevent fluid flow through the fluid passage when the passage blocking mechanism is in the first position.

12. The thermal recirculation valve of claim 11, wherein the passage blocking mechanism comprises:
a base disposed on the inlet side of the fluid passage;
a plunger connected to the base comprising a first plunger portion and a second plunger portion, wherein the second plunger portion extends through the fluid passage to the outlet side of the fluid passage;
the seal member disposed on the first plunger portion.

13. The thermal recirculation valve of claim 12, wherein the passage blocking mechanism further comprises a handle comprising a handle slot disposed within, the handle slot configured to receive the second plunger portion, the handle comprising a first handle position and a second handle position, wherein in first handle position the handle slot is configured to engage the second plunger portion and cause the passage blocking mechanism to transition to the first position and prevent fluid flow through the fluid passage, and wherein in the second handle position the handle slot is configured to release the second plunger portion and cause the passage blocking mechanism to transition to the second position and allow fluid flow through the fluid passage.

14. The thermal recirculation valve of claim 13, wherein the seal member comprises a first seal position when the passage blocking mechanism is in the first position and a second seal position when the passage blocking mechanism is in the second position, wherein in the first seal position the seal member covers the fluid passage to prevent fluid flow through the fluid passage and in the second seal position the seal member is disposed away from the fluid passage toward the inlet side and allows fluid flow through the fluid passage.

15. The thermal recirculation valve of claim 13, wherein the handle further comprises an actuating member, the actuating member rotatable to transition the handle from the first handle position to the second handle position.

16. The thermal recirculation valve of claim 11, wherein the passage blocking mechanism comprises
a plunger comprising a first plunger end and a second plunger end, the plunger disposed on the outlet side of the fluid passage;
a rib portion disposed between the first plunger end and the second plunger end; and
the seal member disposed on the second plunger end.

17. The thermal recirculation valve of claim 16, wherein the passage blocking mechanism further comprises a handle comprising a pinion disposed within, the pinion configured to engage the rib portion, the handle comprising a first handle position and a second handle position, wherein in first handle position pinion is configured to engage the rib portion and cause the passage blocking mechanism to transition to the first position and prevent fluid flow through the fluid passage, and wherein in the second handle position the pinion is configured to release the rib portion and cause the passage blocking mechanism to transition to the second position and allow fluid flow through the fluid passage.

18. The thermal recirculation valve of claim 17, wherein the handle further comprises an actuating member, the actuating member rotatable to transition the handle from the first handle position to the second handle position, wherein rotation of the actuating member causes vertical motion of the plunger.

19. The thermal recirculation valve of claim 17, wherein the seal member comprises a first seal position when the passage blocking mechanism is in the first position and a second seal position when the passage blocking mechanism is in the second position, wherein in the first seal position the seal member covers the fluid passage to prevent fluid flow through the fluid passage and in the second seal position the seal member is disposed away from the fluid passage toward the inlet side and allows fluid flow through the fluid passage.

20. The thermal recirculation valve of claim 11, wherein the passage blocking mechanism further comprises:
a plunger connected to the outlet side and the plunger aligned with the fluid passage, the plunger comprising a first plunger end and a second plunger end, wherein the plunger is movable to transition the passage blocking mechanism between the first position the second position; and
the seal member disposed on the second plunger end, the seal member being aligned with the fluid passage, the seal member having a diameter at least equal to a diameter of the fluid passage.
